(19) United States
(12) Patent Application Publication
(10) Pub. No.: US 2024/0328255 A1
(43) Pub. Date: Oct. 3, 2024

(54) Climbing Stick

(71) Applicant: Fourth Arrow, LLC, Comstock Park, MI (US)

(72) Inventors: Robert M. Wynalda, JR., Comstock Park, MI (US); David Wynalda, Comstock Park, MI (US)

(21) Appl. No.: 18/618,410

(22) Filed: Mar. 27, 2024

Related U.S. Application Data
(60) Provisional application No. 63/493,071, filed on Mar. 30, 2023.

(51) Int. Cl. E06C 1/34; E06C 1/38

(52) U.S. Cl. CPC E06C 1/34; E06C 1/381

(57) ABSTRACT

A nestable climbing stick includes a central frame member, steps, and gripping feet that can be formed from a single piece of material. The climbing stick steps projecting from a central frame member. The steps define an angle in the range of 140 degrees to 160 degrees and are angled forward away from the structure to which the climbing stick is mounted. A pair of gripping feet project rearwardly from each of two mounting legs which project rearwardly from the central frame member. The legs form an angle in a range from twenty degrees to forty degrees. The gripping feet are extensions of the legs. The feet have different configurations which help the climbing stick to be securely mounted.

### CROSS-REFERENCE TO RELATED APPLICATIONS

This application claims the benefit of U.S. Provisional Patent application No. 63/493,071 filed Mar. 30, 2023, the disclosures of which are incorporated herein by reference.

### BACKGROUND

A climbing stick is a piece of equipment used by climbers and hunters to ascend or descend trees or other structures. It is typically a long, narrow device made of lightweight materials such as aluminum or carbon fiber, with a series of steps or platforms. The steps or platforms allow the climber to place their feet and use the stick as a support while ascending or descending the tree. Climbing sticks are often used in conjunction with other tree climbing equipment such as harnesses, ropes, and tree stands. They are popular among hunters who use them to gain a better vantage point while scouting or hunting game from a tree stand.

Climbing sticks typically have a simple and lightweight design that allows for easy transport and assembly. They are usually made up of several sections that work together or can be joined together to form a longer pole. Each section of the climbing stick typically has a series of steps or platforms attached to it, which are spaced at regular intervals along the length of the stick. The steps or platforms provide a stable surface for the climber to place their feet and rest while ascending or descending the tree.

Climbing sticks are typically held to the tree using straps or ropes. The straps or ropes are usually made of sturdy materials such as nylon or polyester, and are wrapped tightly around the tree trunk and secured using buckles or other types of fasteners. Some climbing sticks also come with cam buckles or ratchet straps that can be tightened to create a more secure attachment to the tree. The straps or ropes are usually designed to be adjustable, allowing the climber to easily fit the stick to the diameter of the tree trunk.

### SUMMARY OF THE DISCLOSURE

The disclosure provides a climbing stick. The climbing stick of the exemplary configuration includes four steps projecting from a central frame member. The steps define a first angle in the range of 140 degrees to 160 degrees. The steps are angled forward away from the structure (typically a tree or a pole) to which the climbing stick is mounted. A pair of gripping feet project rearwardly from each of two mounting legs which project rearwardly from the central frame member. The legs form a second angle in the range of twenty degrees to forty degrees. The gripping feet are extensions of the legs. Each foot is located in the same reference plane as the leg from which it projects. Each foot is thus contained in a vertical reference plane when the climbing stick is positioned vertically. This foot configuration helps the foot grip into a tree to provide a secure support for the user. As the climbing stick is pushed into a structure such as a tree, the feet enter the tree at angles and are thus compressing tree material between them.

The climbing stick nests with copies of itself to provide compact dimensions for transport and storage. Two or more of the climbing sticks can be stacked in a nested configuration. The climbing stick includes two cleats about which a retaining cord is wrapped when the climbing stick is installed. The cleats are angled inwardly so that they fit between the legs of the climbing stick nested in front of the cleats. Cleat openings defined next to the cleats also provide space for the cleats to nest.

The disclosure provides a single piece design for the climbing stick. The climbing stick can be made from a single piece of material such as steel or aluminum by cutting the elements from a flat blank and bending the material to form the climbing stick. There are no joint between different sections of material that must be formed and can be the site of failures. There are also no fasteners.

The upper gripping feet define a point adapted to engage the structure to which the climbing stick is being mounting. The point of the upper gripping feet is formed by an upper edge and a lower edge that form an angle of forty to fifty degrees. The lower gripping feet include a chamfer edge between the upper edge and the lower edge. The point of the lower gripping feet is formed between the upper edge and the chamfer edge. The chamfer edge allows the climbing stick to slide downwardly along the mounting structure while the retaining cord is tightened. This helps to secure the climbing stick to the mounting structure. The angle defined between the chamfer edge and the upper edge is ninety to one hundred degrees. The points of the lower gripping feet are thus less sharp than the points of the upper gripping feet.

The central frame can define openings to reduce the weight of the climbing stick.

The preceding non-limiting aspects of the disclosure, as well as others, are more particularly described below. A more complete understanding of the devices, assemblies, and methods can be obtained by reference to the accompanying drawings, which are not intended to indicate relative size and dimensions of the assemblies. In those drawings and the description below, like numeric designations refer to components of like function. Specific terms used in that description are intended to refer only to the particular structure of the embodiments selected for illustration in the drawings, and are not intended to define or limit the scope of the disclosure.

### BRIEF DESCRIPTION OF DRAWINGS

FIG. 1 is a perspective view of an exemplary configuration of a climbing stick.

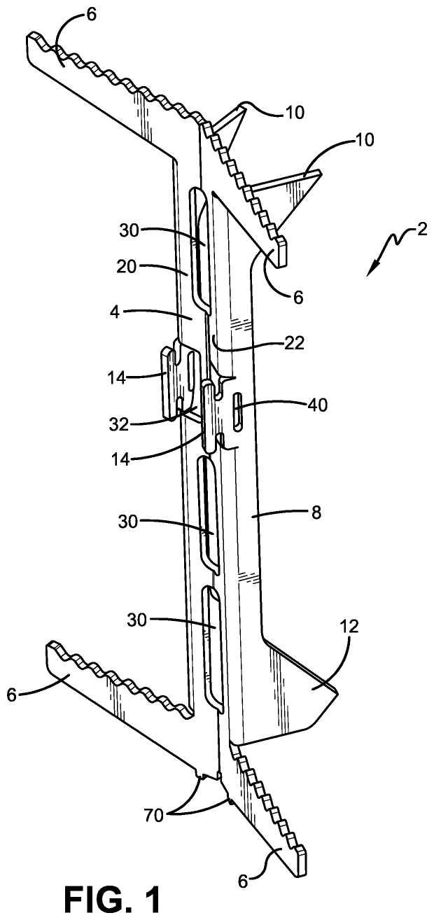

FIG. 2 is a front elevation view thereof.

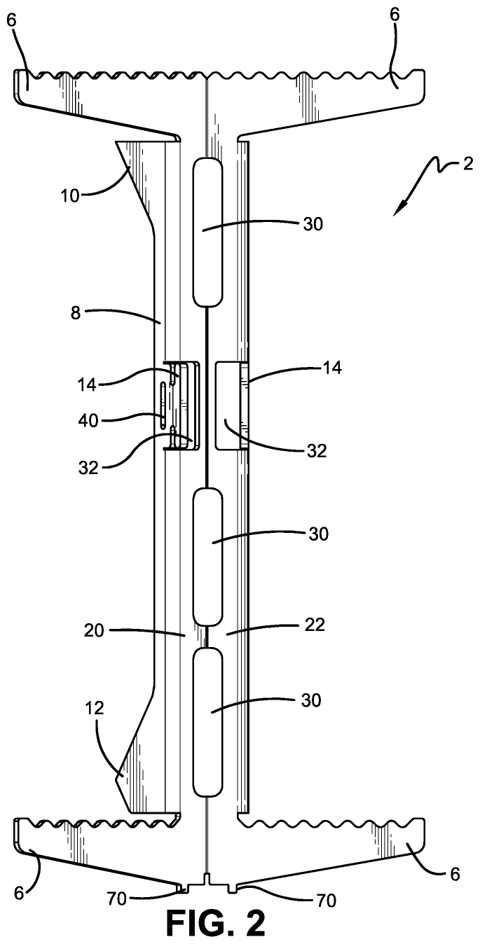

FIG. 3 is a right side elevation view thereof.

FIG. 4 is a left side elevation view thereof.

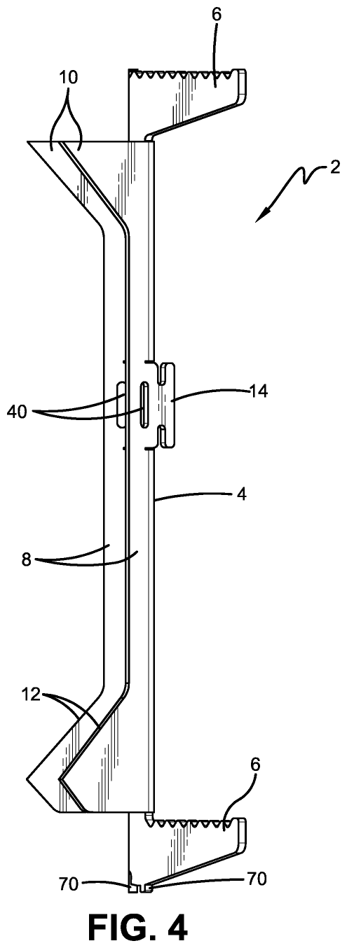

FIG. 5 is a rear elevation view thereof.

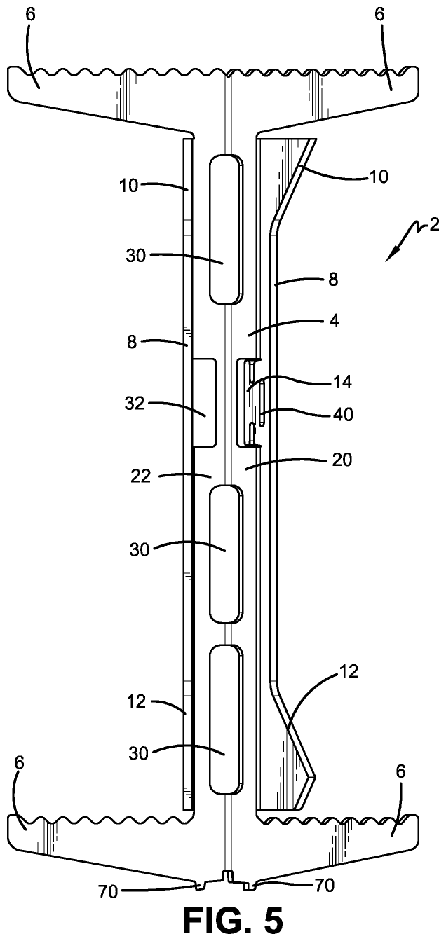

FIG. 6 is a top plan view thereof.

FIG. 7 is a bottom plan view thereof.

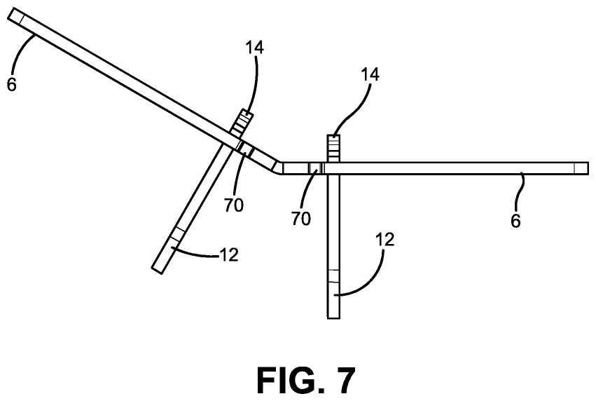

FIG. 8 is a perspective view of two climbing sticks nested for compact storage and transport.

FIG. 9 is a perspective view of two climbing sticks secured to a tree.

FIG. 10 is an enlarged perspective view of how the retaining cord is secured to the climbing stick.

### DETAILED DESCRIPTION OF THE INVENTION

This description of exemplary embodiments is intended to be read in connection with the accompanying drawings, which are to be considered part of the entire written description. The drawing figures are not necessarily to scale and certain features may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “joined,” “connected,” and “interconnected,” refer to a relationship wherein structures are secured or attached to one another either directly or indirectly through intervening structures, as well as both movable or rigid attachments or relationships, unless expressly described otherwise.

The disclosure provides an exemplary climbing stick 2. Climbing stick 2 generally includes a central frame member 4 from which steps 6 extend. First and second optional legs 8 extend rearward from central frame member 4. An upper gripping foot 10 and a lower gripping foot 12 extends from each leg 8. In another configuration, gripping feet 10 and 12 can extend directly from central frame member 4. Climbing stick 2 also includes two cleats 14 about which a retaining cord 16 can be secured. These elements can be integral to one another and formed from a single piece of material. When formed from a single piece of material, the elements are cut from a flat blank (steel or aluminum) and bent to form climbing stick 2. Forming climbing stick 2 in this manner eliminates joints, welds, and fasteners which eliminates fabrication steps. In another embodiment, the elements can be formed individually and joined with fasteners or welds. In a further embodiment, climbing stick 2 can be molded to the final shape.

In the exemplary configuration, four steps 6 extend from central frame member 4. The upper edge of each step can be serrated or provided with other projections that grip boot treads. Each upper edge is perpendicular to central frame member 4 so that it is horizontal when climbing stick 2 is mounted vertically. In the exemplary configuration, two upper steps extend from opposite sides of the upper end of central frame member 4 and two lower steps extend from opposite sides of the lower end of central frame member 4. In other configurations, steps 6 can be vertically offset such that the lower right step is positioned above the lower left step and the upper right step is positioned above the upper left step. Other offset configurations are contemplated. Additional or fewer number of steps 6 can be provided.

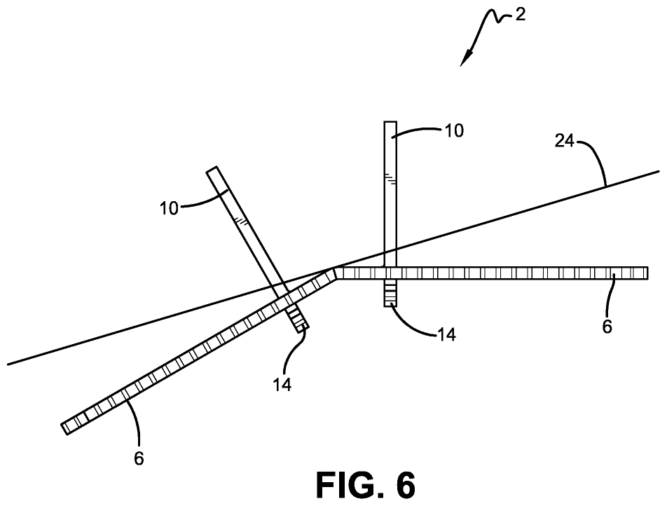

Central frame member 4 is angled along its longitudinal dimension (vertical when in use) such that its left 20 and right 22 sides form an angle in the range of 140 to 160 degrees. In this text, the support structure to which climbing stick 2 is mounted is said to be behind climbing stick 2. The left 20 and right 22 sides of central frame member 4 are bent forward from an imaginary reference plane 24 as shown in FIG. 6 although this may be achieved by bending one side to the desired angle. Angling steps 6 forwardly provides extra space from the support structure for the user's feet to use steps 6.

Central frame member 4 defines a plurality of openings 30 which reduce the weight of climbing stick 2 while also providing ways to fasten a group of stacked climbing sticks together and to secure them to a pack.

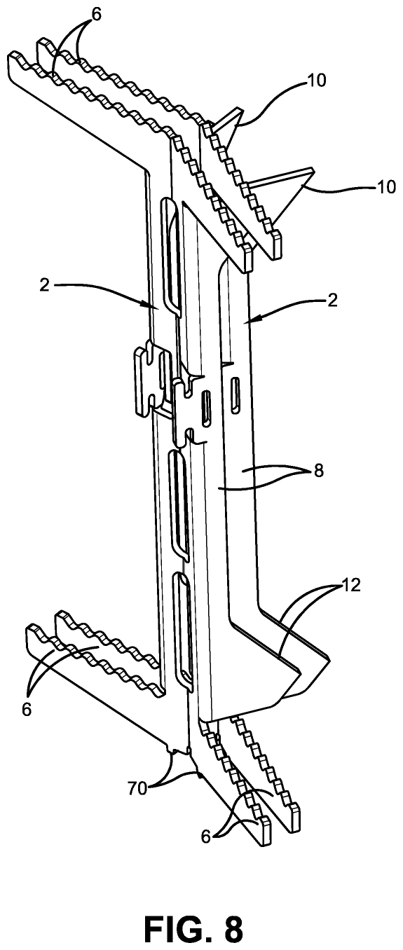

Legs 8 increase the stiffness of climbing stick 2 and increase the space between steps 6 and the mounting structure to which climbing stick 2 is secured. Legs 8 form an angle of between twenty and forty degrees when viewed from above as shown in FIG. 6. This angle helps secure feet 10 and 12 to a structure like a tree where a portion of the tree is compressed between the opposed feet when they are pressed into the tree. Angling legs 8 and feet 10 and 12 outwardly also allows climbing sticks 2 to be nested together as shown in FIG. 8. Cleats 14 from a rear nested climbing stick 2 are located between legs 8 of front climbing stick 2. Central frame member 4 defines a cleat opening 32 inwardly of each cleat 14. In some embodiments, portions of cleats 14 from the rear climbing stick 2 can be located in the corresponding cleat opening 32 when climbing sticks 2 are nested.

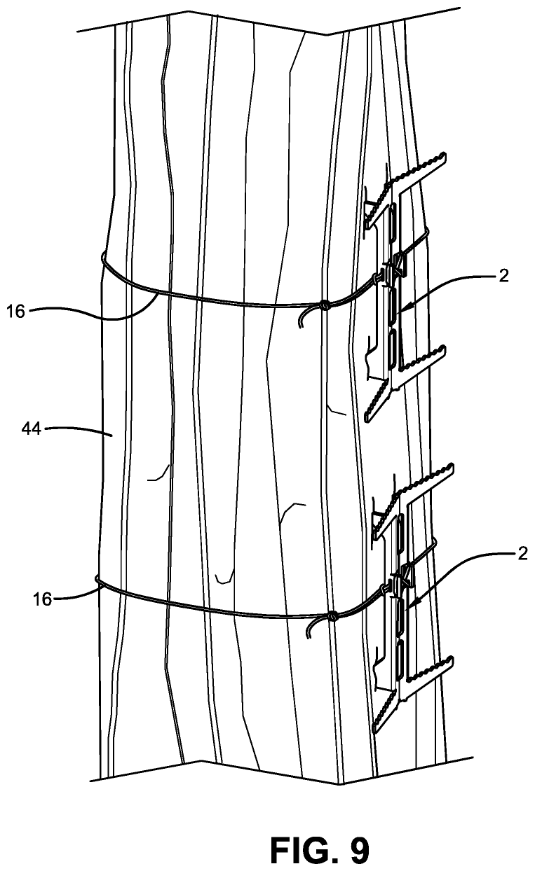

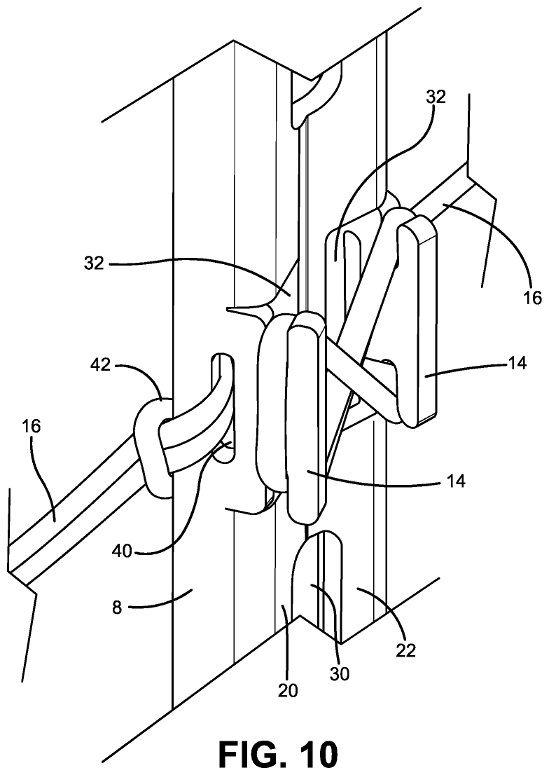

Legs 8 also provide material to define a cord opening 40 behind each cleat 14. Retaining cord 16 can be looped through either or both cord openings 40. In the exemplary mounting configuration depicted in FIGS. 9 and 10, retaining cord 16 is doubled over at one end to form a loop 42 that is passed through cord opening 40. Both ends of retaining cord 16 are then passed through loop 42. Retaining cord 16 is then wrapped around the mounting structure 44 which is depicted as being a tree 44. Retaining cord 16 is then wrapped around each cleat twice to secure climbing stick 2 to structure 44.

Upper 10 and lower 12 gripping feet extend rearwardly from each leg 8 and are located in the same reference plane as the leg 8 from which they extend. Gripping feet 10 and 12 are thus in a vertical reference plane when climbing stick 2 is mounted vertically. When viewed from above, the left side gripping feet are perpendicular to the left side steps and the right side gripping feet are perpendicular to the right side steps.

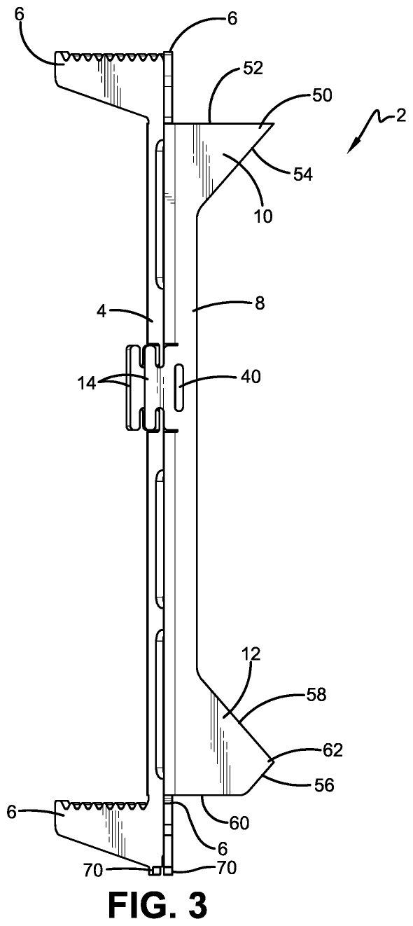

With reference to FIG. 3, upper gripping feet 10 define a point 50 adapted to engage the structure to which climbing stick 2 is being mounting. Point 50 of upper gripping feet 10 is formed by an upper edge 52 and a lower edge 54 that form an angle in a range of forty degrees to fifty degrees. Lower gripping feet 12 include a chamfer edge 56 between an upper edge 58 and a lower edge 60. The point 62 of lower gripping feet 12 is formed between upper edge 58 and chamfer edge 56. Chamfer edge 56 allows climbing stick 2 to somewhat slide or move downwardly along the mounting structure while retaining cord 16 is tightened while the user is pushing inward and downward on climbing stick 2 against the structure. This helps to secure climbing stick 2 to bite into the mounting structure and provide a secure mount. As climbing stick 2 slides, retaining cord 16 stay higher which creates tension and pulls climbing stick 2 tight to the mounting structure. Chamfer edge 56 helps climbing stick 2 to slide down the mounting structure slightly without immediately digging in. The angle defined between chamfer edge 56 and upper edge 58 is in a range from ninety degrees to one hundred degrees which is about double the angle of point 50 of upper feet 10. Points 62 of lower gripping feet 12 are thus less sharp than points 50 of upper gripping feet 10.

When two climbing sticks 2 are nested together as shown in FIG. 8, portions of both cleats 14 of the rear climbing stick 2 are located directly between legs 8 of the front climbing stick 2. Likewise, portions of rear gripping feet 10 and 12 are located directly between the corresponding gripping feet 10 and 12 of the front climbing stick 2. Also, as described above, openings 32 provide spaces to accommodate cleats 14 from the rear climbing stick 2 in certain embodiments.

Climbing sticks 2 can be mounted one above the other as shown in FIG. 9. These can be spaced apart as shown or in direct contact. Spacers 70 extends down from the lower end of central frame member 4. These can engage the ground and provide grip, engage another climbing stick 2, or a branch.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the above description and attached illustrations are examples and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps. Up, down, left, right, top, and bottom are in reference to the orientation of the drawings.

1. An assembly of nested climbing sticks comprising:
a front climbing stick and a rear climbing stick; the rear climbing stick being nested behind the front climbing stick;
each of the climbing sticks including an elongated central body having spaced legs projecting rearwardly from the central body;
each of the climbing sticks further including a cleat projecting forwardly from the central body; and
the cleat of the rear climbing stick being positioned between the legs of the front climbing stick.

2. The assembly of claim 1, wherein front ends of the legs are spaced closer together than rear ends of the legs such that the legs are angled away from each other in the rearward direction.

3. The assembly of claim 1, wherein each of the climbing sticks further includes a plurality of steps projecting from the central body.

4. The assembly of claim 3, wherein each of the steps projects forwardly from the central body.

5. The assembly of claim 1, wherein each of the climbing sticks includes an upper gripping foot and a lower gripping foot projecting rearwardly from each leg.

6. A climbing stick comprising:
an elongated central frame member;
upper and lower first steps projecting outwardly from the elongated central frame member; the upper first step being spaced from the lower first step by first distance along the elongated central frame member;
upper and lower second steps projecting outwardly from the elongated central frame member;
the upper second step being spaced from the lower second step by second distance along the elongated central frame member;
a first leg projecting rearwardly from the elongated central frame member;
upper and lower first gripping feet projecting rearwardly from the first leg;
a second leg projecting rearwardly from the elongated central frame member;
upper and lower second gripping feet projecting rearwardly from the second leg;
the upper first step and the upper second step defining a first angle in a range of 140 degrees to 160 degrees; and
the first leg and the second leg defining a second angle in a range of 20 degrees to 40 degrees.

7. The climbing stick of claim 6, wherein the first distance is equal to the second distance.

8. The climbing stick of claim 6, wherein the lower first step and the lower second step define a third angle that is the same as the first angle.

9. The climbing stick of claim 6, wherein the central frame member includes a first wall portion and a second wall portion.

10. The climbing stick of claim 9, wherein the upper and lower first steps are coplanar with the first wall portion and the upper and lower second steps are coplanar with the second wall portion.

11. The climbing stick of claim 10, wherein the upper and lower first gripping feet are coplanar with the first leg and the upper and lower second gripping feet are coplanar with the second leg.

12. The climbing stick of claim 11, wherein front ends of the legs located at the central frame member are spaced closer together than rear ends of the legs such that the legs are angled away from each other in the rearward direction.

13. The climbing stick of claim 12, wherein the first leg is perpendicular to the first wall portion and the second leg is perpendicular to the second wall portion.

14. The climbing stick of claim 6, further comprising first and second spaced cleats projecting forward of the central frame member.

15. The climbing stick of claim 14, wherein rear ends of the cleats located at the central frame member are spaced farther apart than front ends of the cleats such that the cleats are angled toward each other in the forward direction.

16. A climbing stick comprising:
an elongated central frame member;
a first step projecting outwardly from the elongated central frame member;
a second step projecting outwardly from the elongated central frame member;
upper and lower first gripping feet projecting rearwardly from the central frame member;
upper and lower second gripping feet projecting rearwardly from the central frame member;
each upper gripping foot defining an upper point between an upper edge and a lower edge;
each lower gripping foot having a chamfer edge connecting an upper edge and a lower edge; the chamfer edge and upper edge defining a lower point; and
the lower point defining an angle that is larger than the upper point.

17. The climbing stick of claim 16, wherein the central frame member includes a first wall portion and a second wall portion; the first step being coplanar with the first wall portion; and the second step being coplanar with the second wall portion.

18. The climbing stick of claim 16, wherein front ends of the upper first and upper second gripping feet are spaced closer together than rear ends of the upper first and upper second gripping feet such that the upper first and upper second gripping feet are angled away from each other in the rearward direction.

19. The climbing stick of claim 18, wherein front ends of the lower first and lower second gripping feet are spaced closer together than rear ends of the lower first and lower second gripping feet such that the lower first and upper second gripping feet are angled away from each other in the rearward direction.

20. The climbing stick of claim 16, wherein the upper and lower first gripping feet are perpendicular to the first step and wherein the upper and lower second gripping feet are perpendicular to the second step.
